(19) United States
(12) Patent Application Publication
(10) Pub. No.: US 2014/0247442 A1
(43) Pub. Date: Sep. 4, 2014

(54) SPECTRORADIOMETER DEVICE AND APPLICATIONS OF SAME

(71) Applicants: Joseph E. Johnson, Readfield, ME (US); David L. Wooton, Beaverdam, VA (US)

(72) Inventors: Joseph E. Johnson, Readfield, ME (US); David L. Wooton, Beaverdam, VA (US)

(73) Assignee: MicrOptix Technologies, LLC

(21) Appl. No.: 13/192,418

(22) Filed: Jul. 27, 2011

Related U.S. Application Data
(60) Provisional application No. 61/368,083, filed on Jul. 27, 2010.

(51) Int. Cl. G01J 3/28

(52) U.S. Cl. CPC G01J 3/28
USPC 356/51; 356/402; 356/364

(57) ABSTRACT

A light weight, portable spectroradiometer device has an optical system that directs incoming wavelengths of light to impinge upon a three-dimensional sensor comprised of a linear variable filter in direct contact with a photodiode array. The linear variable filter can be a specific band pass filter coating that has been geometrically wedged in one direction. The incoming wavelengths of light are transmitted through the three-dimensional sensor and differentiated into the pixels to be further processed into digital signals. A standard light source, either external or internal to the device, and emitting specified intensities over wavelengths may also be used to calibrate the spectroradiometer device, and samples of light with unknown intensities may be compared to the standard light source. The compact geometry of the optical system and sensor allows the device to be a compact, light weight three-dimensional spectroradiometer containing no moving parts and having a rapid measurement time.

This application claims priority under 35 U.S.C. §119(e) from provisional patent application Ser. No. 61/368,083 filed on Jul. 27, 2010, incorporated herein by reference, for all purposes, in its entirety.

### BACKGROUND OF THE INVENTION

1. Field of the Invention

The present invention relates to a compact and portable, three-dimensional spectroradiometer for acquiring spectral data comprising intensities over wavelengths for a light source, and converting the spectral intensities into pixels using a three-dimensional linear variable filter attached to a photodiode array, without any moving parts.

2. Background Art

Generally, there have been a variety of different spectroradiometers that exist and have many common elements. The following United States patents and one Japanese patent publication provide some examples:

| | | |
|---|---|---|
| 5394237 | February 1995 | Chang et al. |
| 5734473 | March 1998 | Gerhart et al |
| 5821535 | October 1998 | Dombrowski et al. |
| 5949074 | September 1999 | Dombrowski et al. |
| 5949480 | September 1999 | Gerhart et al. |
| 7339665 | March 2008 | Imura |
| 7365850 | April 2008 | Imura |
| 7684041 | March 2010 | Ebita et al. |
| 06-074823 | March 1994 | Japan |

### SUMMARY OF THE INVENTION

It is an object of the invention to provide a spectroradiometer with an integrated spectral three dimensional sensor. The term integrated is used to indicate that the device is to be fabricated as a single structure, where the components are intimately interconnected in a miniaturized platform.

The embodiment of the invention described herein uses a miniaturized spectral sensing device, a major advancement in measurement opportunity over the status quo, and overcomes issues related to size or space occupied in the laboratory, or the size of a portable spectroradiometer. Each device is intended to provide the functionality of a normal spectroradiometer or spectral analyzer, and with a significantly reduced size for the total package. In addition to the portability, the present invention also eliminates the use of moving parts and the consequent mechanical breakdown that is found in other spectral radiometers. The three-dimensional nature of the sensing system is a part of the reason that no moving parts are required. In addition, no sample holder is required.

The spectral sensing component of the embodiment of the invention is based on existing optical sensing technology constructed in accordance with the principles set forth in commonly-owned U.S. Pat. Nos. 7,057,156 and 7,459,713, each incorporated herein by reference, in its entirety. The spectral sensing systems described feature specially assembled detection devices that incorporated the spectral selection elements required to generate the spectroscopic data for subsequent analysis. One set of examples are linear variable filter (LVF) systems based on a silicon photodiode array that can offer spectral ranges of 360 nm to 700 nm (visible) and 600 nm to 1100 nm (short wave near Infrared (NIR), or any combination of range or ranges from about 360 nm to about 1100 nm. This also includes multi-element detectors that feature a filter array. The current implementations feature the spectral selection devices, nominally in the form of interference filters (LVF or otherwise) that are produced as an integrated component as part of the detector array fabrication, either by the array manufacturer or by a company specializing in thin film deposition is a compact, three dimensional sensor with no moving parts.

FIGS. 1-3 of U.S. Pat. No. 7,057,156 are specifically incorporated herein by reference. FIG. 1 is an embodiment of components comprising a spectroradiometer: an optical system; a linear variable filter directly attached to a photodiode array. The optical system receives light from a light source, where it then is directed and transmits through a three-dimensional sensor comprising a linear variable filter (LVF) and a photodiode array. The LVF sorts the incoming wavelengths of light. The LVF is directly attached to a photodiode array in a three dimensional geometry, that then differentiates the wavelengths into different pixels for further processing. FIG. 2 shows the optical filters and detectors used in the present invention. FIG. 3 is an example of the electronic components of the spectroradiometer invention in a three dimensional geometry that differentiates the wavelengths into different pixels for further processing.

As in U.S. Pat. Nos. 7,057,156 and 7,459,713, the embodiment described herein includes full integration of the spectral sensing, and the spectral measurement electronics. The sample interface, the light source for the spectral measurement, the spectral detection system, the primary signal acquisition electronics, and the signal processing and display of the final analytical results are provided within a single package. Unlike the cited references, the current invention uses wavelengths of light from an external source, thus measuring the spectral properties of the external light source. Properties include, but are not limited to intensity, relative intensity, and wavelength. The systems can include hardwired communications to a PC, laptop or handheld PDA via standard interfaces, such as USB, and can have the option for wireless communications via one of more of the standard protocols such as BlueTooth, ZigBee, IEEE 802.11 b/g or equivalent standards.

Thus, in general terms, described herein is a spectroradiometer having an optical system that receives light from a light source external to the spectroradiometer. The optical system comprises a three dimensional sensor, said three dimensional sensor comprising a linear variable filter; and a photodiode array in a geometry that differentiates the wavelengths into different pixels for further processing, the photodiode array being directly attached to said linear variable filter. Also described herein are methods for use of this apparatus, and various methods generally.

### BRIEF DESCRIPTION OF THE DRAWINGS

The foregoing aspects and other features of the present invention are explained in the following description, taken in connection with the accompanying drawings, wherein:

FIG. 1 is an enlarged cross-sectional view of a sensing system in accordance with an embodiment of the invention.

FIG. 2 is a block diagram of a system including a sensing system in accordance with FIG. 1.

FIGS. 3A to 3D are four graphs of measurements taken using the system of FIG. 1 and FIG. 2.

FIGS. 4A to 4D are four graphs of measurements taken using the system of FIG. 1 and FIG. 2.

FIGS. 5A to 5C are three graphs of measurements taken using the system of FIG. 1 and FIG. 2

### DETAILED DESCRIPTION OF THE PREFERRED EMBODIMENT

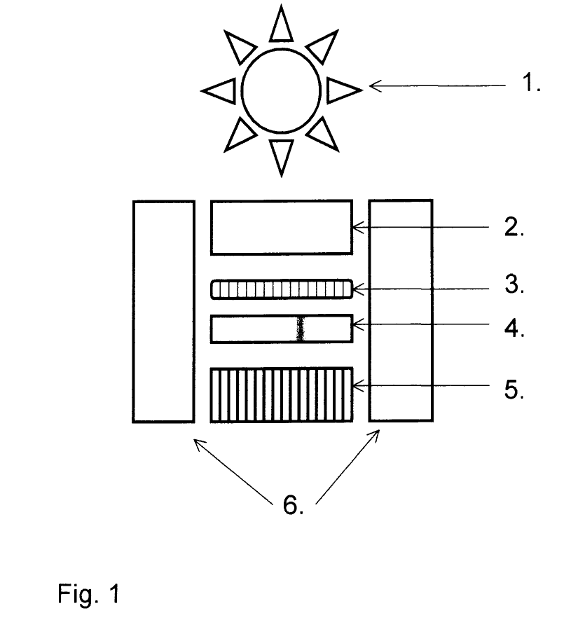

Referring to FIG. 1, there is shown an enlarged cross-sectional view of a sensing system of an apparatus incorporating features of the present invention. Although reference will be made to the single embodiment shown in the drawings, it should be understood that the invention can be embodied in many alternate forms. In addition, any suitable size, shape or type of elements or materials could be used.

The sensing system is shown in FIG. 1, whereby a light to be measured 1, is aligned with an apparatus that includes a sampling port or window 2, a light pipe 3, a linear variable filter 4, a photodiode array 5 and a containment means or housing 6 that blocks out extraneous light. The sampling port 2 is a transparent window that allows a light or energy source to be directed with light pipe 3, and then to be separated into its different wavelengths through the filter 4 and photodiode array 5.

As used herein, the word light is meant to cover any and all of visible, infrared and ultraviolet wavelengths.

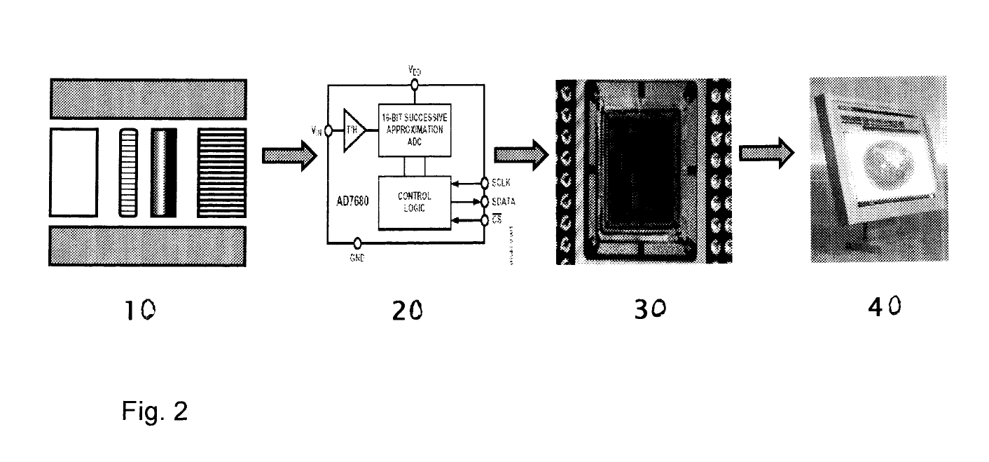

FIG. 2 shows the design for the sensing unit through a usable data display. In FIG. 2, the data from the sensing unit 10 of FIG. 1 is converted to electrical signals using an analog/digital converter (A/D C) 20 and then a microprocessing unit (MPU) 30 that includes a signal conditioner, a signal exchange system, and a controller, all assembled as a single inter-connected structure. Finally, the signal is sent to a display 40, although the data is also stored in the MPU and may be extracted to a computer, as well.

The sampling port or window 2 (FIG. 1) is a transparent window that allows light or an energy source to transmit to the rest of the sensing unit. The window 2 may be comprised of a transparent material, such as silica or plastic. The window 2 should also protect the rest of the sensing system from environmental elements, such as moisture (water), acidic and basic materials, dust and contaminants. The window serves as a protective layer for the light pipe and the linear variable filter that are seated directed below it. The window material should also be chosen with its light absorption capabilities in mind. For example, if ultraviolet light is to be measured, a plastic that absorbs the desired ultraviolet energy should not be used. Preferred window materials include, but are not limited to, silica, especially high optical purity glass, quartz, and transparent plastics, especially poly(acrylate), poly(styrene) and polycarbonate, or combinations thereof. Another key feature of the window is to direct and focus light waves as a lens. The geometry should direct the light to the rest of the sensing system. The presently preferred window material comprises an optically clear polycarbonate.

The window 2, or a portion of the thickness of the window 2, or a separate optical element (not shown)) may also be configured for processing of the light entering the spectroradiometer. For example, window 2, a portion thereof, or a separate optical element can be configured to polarize light to enable spectroradiometer to perform polarization analysis. Window 2, a portion thereof, or a separate optical element may be configured a cut off filter, which blocks light above or below a given wavelength, or as a band pass filter, which allows transmission of light only within a give range of wavelengths.

In principle, a window is not needed. The light waves may directly transmit to the light pipe or to the linear variable filter. However, practically a window is preferred to direct the light and protect the sensing system, or to provide processing as noted above.

A light pipe 3 (FIG. 1) is used to separate and direct the light waves. The light pipe should be transparent in allowing light to pass through, but also help to distinguish light having different energies. Transparent materials, such as silica or plastic may comprise the light pipe. A preferred light pipe material is high optical purity silica.

A linear variable filter 4 (FIG. 1) is a wedge shape, transparent material that separates light energy into fractions depending upon their wavelength. The present embodiment of the invention uses LVFs that range from the ultraviolet, visible, and infrared range.

A photodiode array (PDA) 5 (FIG. 1) is used to convert the light and energy signals into a more usable form. The PDA takes the light energy data and bins it into pixels, for further processing.

The present embodiment of the invention includes the following. The interfacing optics form part of the structure, with no requirement for additional imaging elements such as lenses or mirrors, or moving parts or only two dimensional components, as used in conventional spectroradiometers, and as such is differentiated from such spectroradiometers. The system can be configured to measure light/energy absorption or light/energy emission (as initially discussed in U.S. Pat. No. 7,459,713).

A linear variable filter attached to a sensor, such as a photodiode array, may be used to capture spectral data from a light source. The light source may be a standard light source, which may be used later in comparison with a sample light source. A microprocessor for conditioning the signals output from the spectral sensor may then be used. Additional functions of the microprocessor include spectral data extraction, and the calculation of chemical composition or properties, method and calibration storage, and data communications. The signal exchange system may be a wired or a wireless signal transfer device coupled locally or remotely to the sensor. The primary power for the electronics is provided nominally via batteries, which can be of the rechargeable variety if required. However, the option to use tethered power, such as via a USB cable is included. With batteries, the entire apparatus may be very light, at a weight of 7.4 ounces, and portable.

Further, optical filters may also be used to block out or direct wavelengths of the light source.

### OPERATION

The method determines the total sum of transmission light seen by the detector over the wavelengths of concern, examples are from 400 to 700 nm, although measurements may also be made in the ultraviolet and infrared regions. The peak maximum measurement is also determined and reported. As part of this measurement the total transmission spectrum over the spectral range is measured and reported.

The method is designed to allow the user to balance the spectral transmission to the desired total intensity of a reference source. This reference can be a low level or higher level of light intensity that is referenced to produce the transmission result. This allows a user to define the light level range that is desired.

Generally, a reference source can be used, and the light levels, as determined by signals from all pixels, may be determined. The level that represents the highest intensity can then be used as a reference for all pixels. Measurement of the spectra of other light sources can then be referenced to this highest intensity level.

The measurement is achieved by operation of the instrument without an internal source of illumination. All the illumination to the detector is achieved from the user defined external light sources. The incoming light is measured, referenced with the background or reference light values to generate the transmission spectrum. The sum of all the transmission spectral values from this spectrum are then summed to yield the Total Transmission Light Value.

### APPLICATIONS

Numerous application areas have been identified that can benefit from this spectroradiometer device, and these include, but are not limited to the spectral measurements of sunlight, lighting, such as incandescent, tungsten, mercury vapor, halogen, neon, low pressure sodium, light emitting diodes (LEDs), compact fluorescent lamps (CFL), fluorescent lighting, high intensity discharge, ultraviolet lighting, germicidal lamps, and infrared lighting, cameras, and optical devises, photography and cinematography applications - especially for exposure control or image or scene lighting, flames (such as metal and ions) and temperature and temperature distribution, candle lights, oil lighting, in green houses and near or on plants and other life forms that use light, solar irradiance measurements, photobiology research, drug photostability testing, environmental dosimetry and curing applications, light pollution, and application using light such as filters, polarizers and window treatments to block or modify wavelengths. In addition to the spectral properties that are initially measured, the same properties may be measured over time to understand changes in lighting systems, such as the lifetime of a light, or a reaction caused or influenced by the light, such as plant growth or photoreactions.

Other applications include research for soils, crops, forestry, ecology and plant physiology, analysis of minerals and geological entities, oceanography and water body studies, and composition and properties of ores and mining.

The apparatus and methods described herein also may be applied to emission spectroscopy.

An example, in the chemical field, is qualitative analysis for an unknown metal or metalloid ion based on the characteristic color the salt turns the flame of a Bunsen burner. The heat of the flame converts the metal ions into atoms, which become excited and emit visible light. The characteristic emission spectra can be used to differentiate between some elements. For example, in certain forms, copper provides an emission spectrum of blue, blue-green or green. Sodium, as for example in sodium chloride, provides an intense yellow emission spectrum. The apparatus described herein can be very valuable in interpreting what color or colors (wavelengths) are being emitted, so as to aid in qualitative analysis.

Another example of emission spectroscopy is ICP (Inductively Coupled Plasma) emission spectroscopy. The apparatus described herein may be used for the analysis of spectra produced by this method.

Yet another example of emission spectroscopy measurement is the evaluation of florescence. The apparatus and techniques described herein can be used to obtain and to analyze a spectrum associated with the florescence of a material after it has been excited to fluoresce. The apparatus and techniques described herein can be used with any other emission spectroscopy technique.

### SPECIFIC EXAMPLES

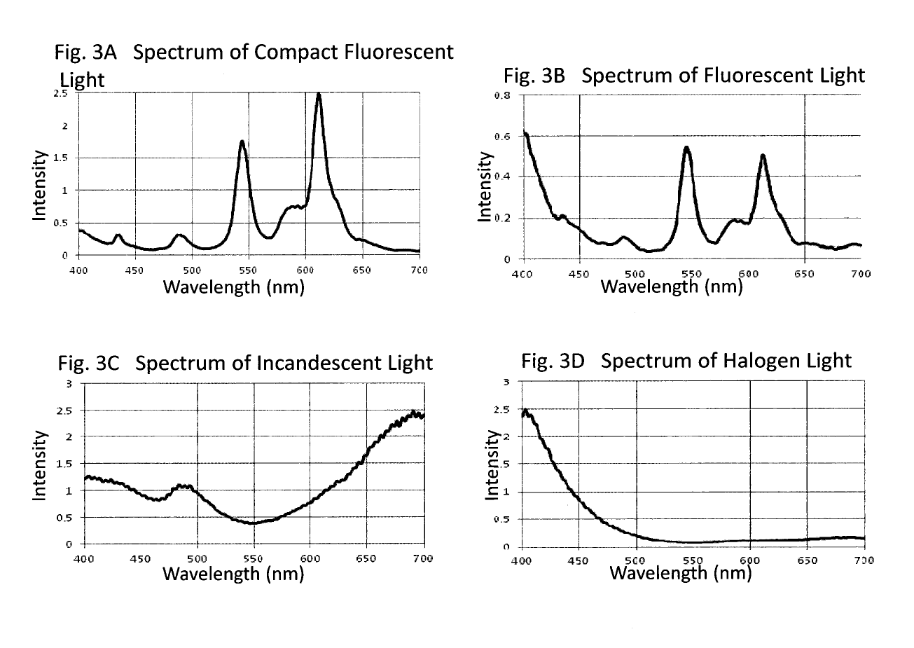

In each of FIGS. 3, 4 and 5 the illustrated embodiment is used to measure various sources. The apparatus is held approximately 1 inch from the light source at measurement. The light source is previously turned on for at least 1 minute. The range of wavelengths represented on the x-axis is 400-700 nanometers. The y-axis represents the relative intensity of light received by the detector. For these examples, the standards against which the intensity is measured is sunlight on a sunny, cloudless day. Other standard may be used.

While the apparatus and methods described herein may be used for the evaluation of artificial and natural light sources, as set forth below, it is noted that a general case is the evaluation of the spectra of broader spectrum LED's and lasers. It has been noted that some of the more recently developed devices have broader spectra than prior devices. There are situations wherein, when these devices are purchased in bulk, the characteristics of each of the same model device is different, and in some cases vary over a relatively large range. It may be necessary to make a custom selection of devices in order match characteristics as closely as possible. The apparatus and methods set forth herein may be used to rapidly and conveniently determine spectral characteristics, and to sort the devices by their characteristics.

FIGS. 3A to 3D illustrate the spectra obtained for the following:

FIG. 3A illustrates a spectrum 312 of a compact fluorescent light, Commercial Electric, model EDXO-14, 14 W, 60 Hz, 200 A.

FIG. 3B illustrates a spectrum 313 of a fluorescent light, LEDV, Trumbell, CT 118 V, 13 W, 60 Hz; pointed bulb.

FIG. 3C illustrates a spectrum 316 of an Incandescent bulb, Lighting One, candelabra bulb, 15 W

FIG. 3D illustrates a spectrum 317 of a Halogen, Lighting One, 50 W, bi pin connection

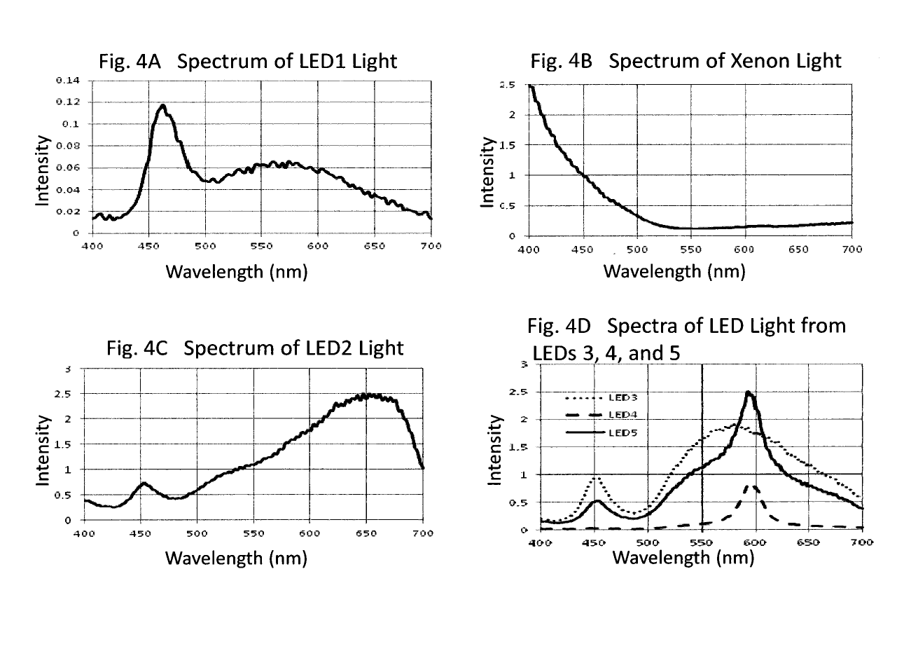

FIGS. 4A to 4D illustrate the spectra obtained for the following:

FIG. 4A illustrates a spectrum 318 of an LED light, Adesso, 120 V, 60 Hz

FIG. 4B illustrates a spectrum 324 of a Xenon light, 1″ diameter, Lighting One, model 4069

FIG. 4C illustrates a spectrum of a 329 LED, Kettler, Invisiled model, white LED light

FIG. 4D illustrates the spectra of LED 3, LED 4, and LED 5; of WAC Lighting, Aura Lighting Model, 1.5W, 24 V DC.

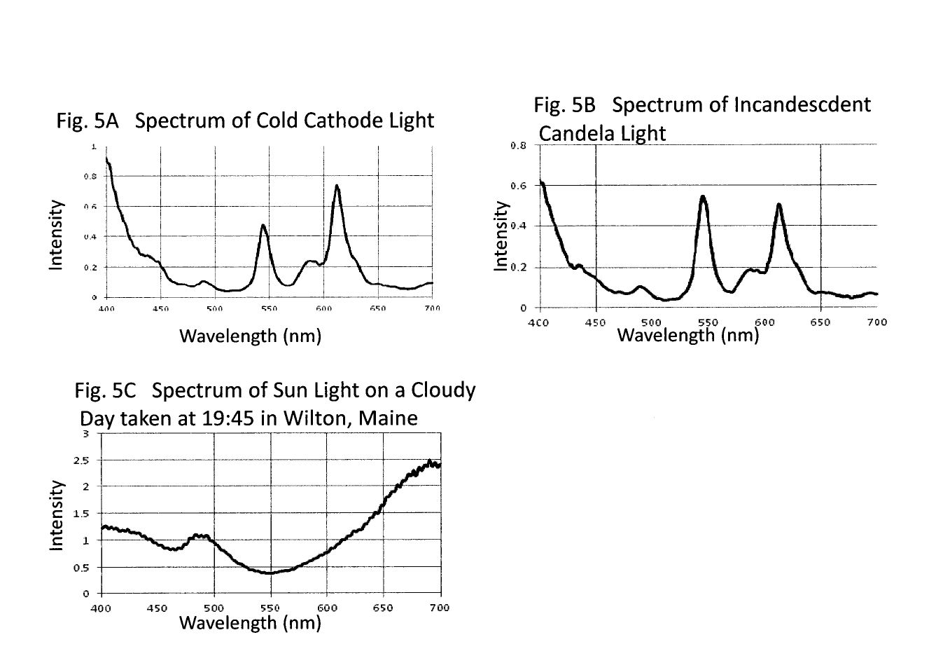

FIGS. 5A to 5C illustrate the spectra obtained for the following:

FIG. 5A illustrates the spectrum 340 of a Cold Cathode light, TCP, Model 8AOCL, 120 volts.

FIG. 5B illustrates the spectrum 343 of an Incandescent Candela light, 2 inch bulb, Lighting One, 120 volts.

FIG. 5C illustrates the spectrum of sunlight wavelength and intensity for a cloudy day.

The last graph is of interest for the analysis of plant growth. It is possible to conduct experiments using the apparatus described herein to determine whether certain plants grow better or develop more desirable characteristics with different intensities and wavelengths of sunlight. For example, by recording the spectrum of light periodically at intervals during a day, and on successive days during a growth period, it is possible to determine the integrated intensity of light in the range of wavelengths measured. This data can be compared to plant growth and characteristics to determine, for example, which crops could do better in a given light radiation environment. It is contemplated that properly normalized experiments may provide significant advantages in the agricultural industries, using an apparatus as described herein. The apparatus may also be configured with a temperature sensor, to provide temperature information, at particular times, or as a function of time.

It should be understood that the foregoing description is only illustrative of the invention. Various alternatives and modifications can be devised by those skilled in the art without departing from the invention. Accordingly, the present invention is intended to embrace all such alternatives, modifications and variances which all described herein or fall within the scope of the appended claims.

What is claimed is:

1. A spectroradiometer having an optical system which receives light from a light source external to the spectroradiometer, the optical system comprising:
a three dimensional sensor, said three dimensional sensor comprising:
a linear variable filter; and
a photodiode array in a geometry that differentiates the wavelengths into different pixels for further processing of intensities of light received at said pixels, the photodiode array being directly attached to said linear variable filter.

2. The spectroradiometer according to claim 1, having no moving parts.

3. The spectroradiometer according to claim 1, wherein the linear variable filter includes a light blocking portion for blocking the light from an imaging area of the photodiode array where an optical image is formed, the light blocking portion being formed on at least one side portion of the linear variable filter.

4. The spectroradiometer according to claim 1, wherein the linear variable filter is of a wedge geometry and has a characteristic of a central wavelength of the light passing through each of a plurality of transmittance sites of the filter, a central wavelength of the light being sequentially varied in a scanning direction of the filter.

5. The spectroradiometer according to claim 1, wherein the intensities of light are measured and differentiated using the photodiode array to produce light signals, so as to differentiate the light signals into pixels for further processing.

6. The spectroradiometer according to claim 1, further comprising a known light source from which intensities of wavelengths of light may be measured, so as to be further compared to a light source with unknown intensities over wavelengths.

7. The spectroradiometer according to claim 6, comprising apparatus for comparing the intensities of wavelengths of light measured from the known light source with a light source for wavelengths in at least one of the ultraviolet, visible, and infrared spectral regions, and combinations of said regions.

8. The spectroradiometer according to claim 7, comprising apparatus for comparing the intensities of wavelengths of light measured from the known light source with light from a light source having wavelengths in the 360 nm to 1100 nm region.

9. The spectroradiometer of claim 1, configured as a three-dimensional spectroradiometer.

10. The spectroradiometer of claim 1, further comprising a light pipe for conducting light received from said light source to said linear variable filter.

11. The spectroradiometer of claim 10, wherein said light pipe is comprised of optically transmissive glass or plastic.

12. The spectroradiometer of claim 10, further comprising a window covering an end of said light pipe that receives the light.

13. The spectroradiometer of claim 12, wherein said window is comprised of a material selected from the group consisting of silica, quartz, a glass, quartz, a transparent plastic, a poly(acrylate), a poly(styrene) and a polycarbonate, and combinations thereof.

14. The spectroradiometer of claim 1, further comprising: a microprocessor for conditioning signals output from the photodiode array.

15. The spectroradiometer of claim 14, wherein said microprocessor performs at least one of the functions in the group consisting of spectral data extraction, calculation of chemical composition or properties, method and calibration storage, and data communications.

16. The spectroradiometer of claim 1, further comprising a light processing window for processing light entering said spectroradiometer.

17. The spectroradiometer of claim 16, wherein said light processing window comprises a polarizer.

18. The spectroradiometer of claim 16, wherein said light processing window comprises one of a band pass filter and a cutoff filter.

19. A method for using the spectroradiometer of claim 1, for spectral analysis of a light source, comprising:
obtaining a first spectrum of a standard light source;
obtaining a second spectrum of light upon which a spectral analysis is to be performed; and
comparing the second spectrum to the first spectrum.

20. A method for using the spectroradiometer of claim 1, comprising:
measuring incoming light,
referencing the incoming light to one of background or reference light value or values to generate a transmission spectrum with transmission spectral values; and
summing the transmission spectral values from the spectrum to yield a total transmission light value.

21. A method for using the spectroradiometer of claim 1, to determine characteristics of a natural or artificial light source.

22. The method of claim 21, wherein the light source is a light emitting diode or a laser.

23. A method for using the spectroradiometer of claim 1, to determine characteristics of sunlight.

24. A method for using the spectroradiometer of claim 1, to determine an integrated intensity of light in a measured range of wavelengths, comprising:
recording spectra of light periodically at intervals during a day, and on successive days during a plant growth period, and
comparing plant growth and characteristics to determine how the integrated intensity of light affects plant growth.

25. A method for using the spectroradiometer of claim 1, to determine the chemical composition of a substance subject to emission spectroscopy.

26. A method for using a spectroradiometer, comprising:
measuring incoming light,
referencing the incoming light to one of background or reference light value or values to generate a transmission spectrum with transmission spectral values; and
summing the transmission spectral values from the spectrum to yield a total transmission light value.

27. A method for using a spectroradiometer to determine an integrated intensity of light in a measured range of wavelengths, comprising:
recording spectra of light periodically at intervals during a day, and on successive days during a plant growth period, and
comparing plant growth and characteristics to determine how the integrated intensity of light affects plant growth.
